(19) United States
(12) Patent Application Publication
(10) Pub. No.: US 2018/0327004 A1
(43) Pub. Date: Nov. 15, 2018

(54) COURSE CORRECTION PROCEDURE GENERATION DEVICE, COURSE CORRECTION PROCEDURE GENERATION SYSTEM, COURSE CORRECTION PROCEDURE GENERATION METHOD, AND PROGRAM

(71) Applicant: MITSUBISHI HEAVY INDUSTRIES ENGINEERING, LTD., Yokohama-shi, Kanagawa (JP)

(72) Inventors: Akihisa KAWAUCHI, Tokyo (JP); Koji UCHIDA, Tokyo (JP); Hiroyuki KONO, Tokyo (JP); Yukihide YANOBU, Tokyo (JP); Eisuke OKANO, Tokyo (JP); Kosaku MURASE, Tokyo (JP)

(73) Assignee: MITSUBISHI HEAVY INDUSTRIES ENGINEERING, LTD., Yokohama-shi, Kanagawa (JP)

(21) Appl. No.: 15/775,270

(22) PCT Filed: Dec. 15, 2016
(86) PCT No.: PCT/JP2016/087356

§ 371 Date: May 10, 2018

(30) Foreign Application Priority Data
Dec. 15, 2015 (JP) 2015-244225

(51) Int. Cl. B61K 9/08; E01B 35/06; B61L 27/00; G06F 17/50

(52) U.S. Cl. CPC B61K 9/08; G06F 17/5009; B61L 27/0055; E01B 35/06

(57) ABSTRACT

Provided is a course correction procedure generation device that comprises: a measurement data acquisition unit for acquiring measurement data on a course; a simulation execution unit with which a travel simulation for simulating travel by the vehicle on the course is executed on the basis of the measurement data and a speed that is established in accordance with the location of the vehicle on the course; and a correction procedure generation unit for generating a correction procedure on the basis of the result of the travel simulation, the correction procedure being information indicative of content for correcting the course.

### TECHNICAL FIELD

The present invention relates to a course correction procedure generation device, a course correction procedure generation system, course correction procedure generation method, and a program.

This application claims priority to Japanese Patent Application. No. 2015-244225 filed in Japan on Dec. 15, 2015, and the content of which is incorporated herein by reference.

### BACKGROUND ART

Ride comfort in a railway and a new transportation system is an important issue directly linked to passenger satisfaction.

In order to improve ride comfort of the vehicle, after completion of planning the course, a work to verify ride comfort by actually running the vehicle and correct a section with bad ride comfort may be performed in some cases. The correction of a section referred to here is the refurbishment of the course in the section.

For example, in a course maintenance plan method described in PTL 1, the measured value of the train fluctuation when the train travels the railway course is compared with the simulation result of the train fluctuation based on the measured value of the course displacement, the cause of the fluctuation is estimated, and a maintenance plan to improve train fluctuation caused by course displacement is developed.

### CITATION LIST

### Patent Literature

[PTL 1] Japanese Unexamined Patent Application Publication No. 2015-40417

### SUMMARY OF INVENTION

### Technical Problem

The ride comfort of the vehicle is influenced not only by the course displacement but also by the travel condition of the vehicle. Thus, a method of verifying ride comfort by actually running the vehicle and correcting the section with bad ride comfort as described above may be used in some cases.

On the other hand, if the ride comfort can be improved without having to actually run the vehicle, the burden on the person in charge of correction can be reduced because the ride comfort verification work by the running of the vehicle becomes unnecessary, and the correction initiation can be advanced.

According to the present invention, there are provid ed a course correction procedure generation device, a cour se correction procedure generation system, a course correc tion procedure generation method, and a program, which are capable of improving ride comfort without having to actua lly run the vehicle.

### Solution to Problem

According to a first aspect of the present invention, a course correction procedure generation device includes a measurement data acquisition unit that acquires measurement data on a course; a simulation execution unit that executes travel simulation which simulates travel of a vehicle on the course, based on the measurement data and a speed determined according to a position of the vehicle on the course; and a correction procedure generation unit that generates a correction procedure which is information indicating correction content of the course, based on a result of the travel simulation.

The course correction procedure generation device may further include a correction procedure evaluation unit that evaluates the correction procedure, the simulation execution unit may perform a travel simulation corresponding to a case where the vehicle travels the course corrected according to the correction procedure, and the correction procedure evaluation unit may evaluate the correction procedure based on a result of the travel simulation performed in the case where the vehicle travels the course corrected according to the correction procedure.

The correction procedure evaluation unit may evaluate the correction procedure by determining whether the ride comfort of the vehicle is good or bad, based on the result of the travel simulation performed in the case where the vehicle travels the course corrected according to the correction procedure.

The correction procedure evaluation unit may determine whether the ride comfort of the vehicle is good or bad, by using a corrected fluctuation amount obtained by correcting a magnitude of fluctuation of the vehicle indicated by the result of the travel simulation performed in the case where the vehicle travels the course corrected according to the correction procedure, based on a prospective amount of a value indicating an error.

The course correction procedure generation device may further include a correction procedure output unit that outputs a correction procedure based on a simulation result determined to have good ride comfort, in a case where the correction procedure evaluation unit determines that the ride comfort is good.

The correction procedure generation unit may determine a grinding work amount and a filling work amount based on a cost of a grinding work of a road surface constituting the course and a cost of a filling work of the road surface, and generates a correction procedure according to the determined grinding work amount and filling work amount.

The correction procedure generation unit may determine the grinding work amount and the filling work amount by performing an optimization calculation using an evaluation function including term for giving a weighting according to the cost of the grinding work to a variable indicating the grinding work amount of the road surface constituting the course and a term for giving a weighting according to the cost of the filling work to a variable indicating the filling work amount of the road surface.

The course correction procedure generation device may further include a measurement data correction unit that corrects a measurement value of a distance of each section based on the measurement value of the distance acquired by the measurement data acquisition unit with respect to a section which distance is known among sections in the course, the simulation execution unit may calculate a position of the vehicle to be simulated in the course, based on the information on the distance corrected by the measurement data correction unit.

The measurement data correction unit may correct the measurement value of the distance of a section having a length equal to or longer than the distance calculated based on the speed of the vehicle and the natural frequency of the vehicle.

According to a second aspect of the present invention, a course correction procedure generation system includes a measurement device that performs measurement of a course and outputs measurement data; a simulation execution unit that executes travel simulation which simulates travel of a vehicle on the course, based on the measurement data and a speed determined according to a position of the vehicle on the course; and a correction procedure generation unit that generates a correction procedure which is information indicating correction content of the course, based on a result of the travel simulation.

According to a third aspect of the present invention, a course correction procedure generation method includes acquiring measurement data on a course; executing travel simulation which simulates travel of a vehicle on the course, based on the measurement data and a speed determined according to a position of the vehicle on the course; and generating a correction procedure which is information indicating correction content of the course, based on a result of the travel simulation.

According to a fourth aspect of the present invention, a program causing a computer to acquire measurement data on a course; execute travel simulation which simulates travel of a vehicle on the course, based on the measurement data and a speed determined according to a position of the vehicle on the course; and generate a correction procedure which is information indicating correction content of the course, based on a result of the travel simulation.

### Advantageous Effects of invention

According to the course correction procedure generation device, the course correction procedure generation system, the course correction procedure generation method, and the program which are described above, it is possible to improve ride comfort without having to actually run a vehicle.

### BRIEF DESCRIPTION OF DRAWINGS

FIG. 1 is a schematic block diagram showing the functional structure of a course correction procedure generation system according to an embodiment.

FIG. 2 is an explanatory diagram illustrating an example in which a vehicle and a course are seen from the front of the vehicle in the embodiment.

FIG. 3 is an explanatory diagram illustrating a schematic structure of a profile meter in the embodiment.

FIG. 4 is a flowchart showing a processing procedure in which a course correction procedure generation device generates a correction procedure in the embodiment.

### DESCRIPTION OF EMBODIMENTS

Hereinafter, embodiments of the present invention will be described, but the following embodiments do not limit the invention according to the claims. In addition, not all combinations of the features described in the embodiments are necessarily essential to the solution means of the invention.

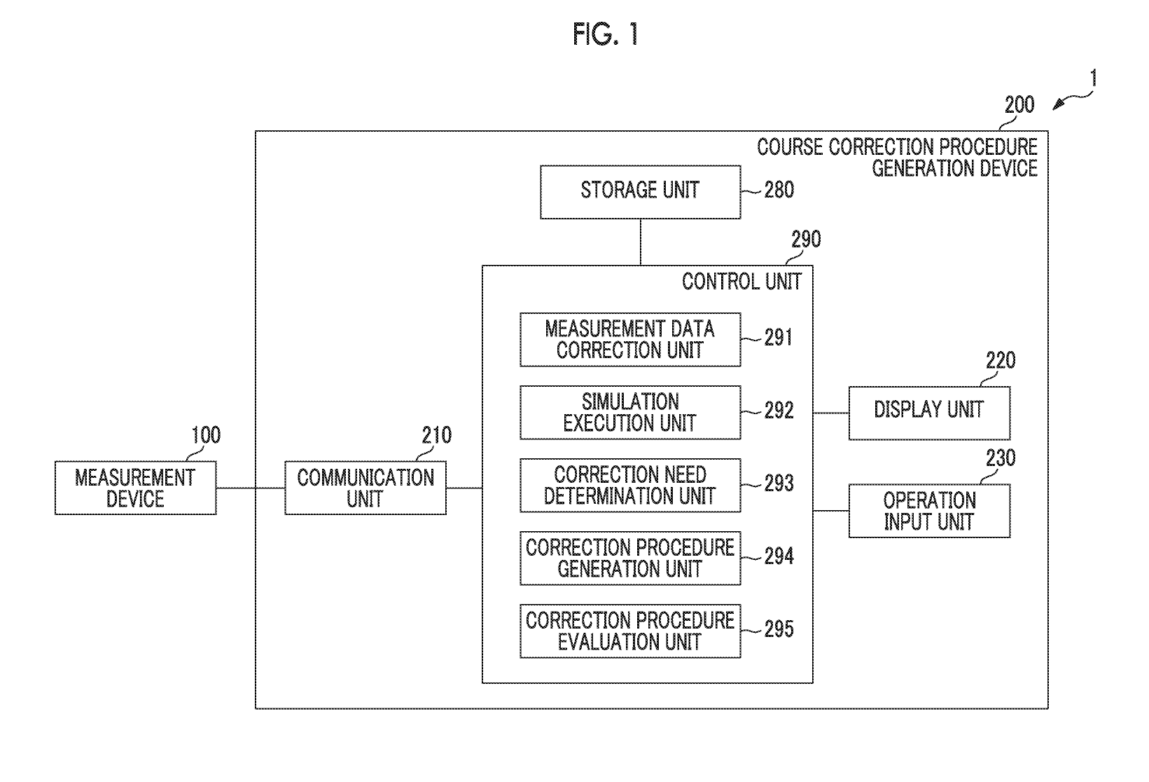

FIG. 1 is a schematic block diagram showing the functional structure of a course correction procedure generation system according to an embodiment. As shown in FIG. 1, a course correction procedure generation system 1 includes a measurement device 100 and a course correction procedure generation device 200. The course correction procedure generation device 200 includes a communication unit 210, a display unit 220, an operation input unit 230, a storage unit 280, and a control unit 290. The control unit 290 includes a measurement data correction unit 291, a simulation execution unit 292, a correction need determination unit 293, a correction procedure generation unit 294, and a correction procedure evaluation unit 295. The correction of a course referred to here is the refurbishment of the course.

The course correction procedure generation system 1 evaluates the ride comfort of the vehicle traveling on the course by travel simulation. In a case where the evaluation result of the ride comfort is equal to or less than the standard, the course correction procedure generation system 1 generates a correction procedure for improving the ride comfort.

In the following, a description is given about the case where the course correction procedure generation system 1 evaluates ride comfort of the automated guideway transit (AGT) vehicle of a side guidance type.

However, the application target of the course correction procedure generation system 1 is not limited to AGT. The course correction procedure generation system 1 can be used for various transportation systems in which at least one of the unevenness of the surface on which the traveling wheel contacts or the unevenness of the guide rails affects the ride comfort of the vehicle. Examples of the surface on which the traveling wheel contacts include the road surface and the upper surface of the rail.

For example, the course correction procedure generation system 1 may be used to evaluate the ride comfort of railway vehicles and improve ride comfort. In this case, the surface on which the traveling wheel contacts is the upper surface of the rail.

The measurement device 100 performs measurement of the course and outputs measurement data. For example, the measurement device 100 measures a road surface unevenness amount, a guide rail unevenness amount, a road surface inclination angle, and a distance between guide rail tracks. The distance between guide rail tracks referred to here is the distance between the guide rails disposed on the left and right of the course. The road surface unevenness amount mainly affects the magnitude of the swing of the vehicle in the vertical direction. The guide rail unevenness amount, the road surface inclination angle, and the distance between guide rail tracks mainly affect the magnitude of the swing of the vehicle in the left and right direction. The measurement device 100 may measure the inclination angle in the left and right direction of the vehicle as an index value indicating the road surface inclination angle.

In addition, the measurement device 100 acquires information indicating the position where measurement is performed. In the following, the information indicating the position where the measurement is performed is referred to as measurement position information.

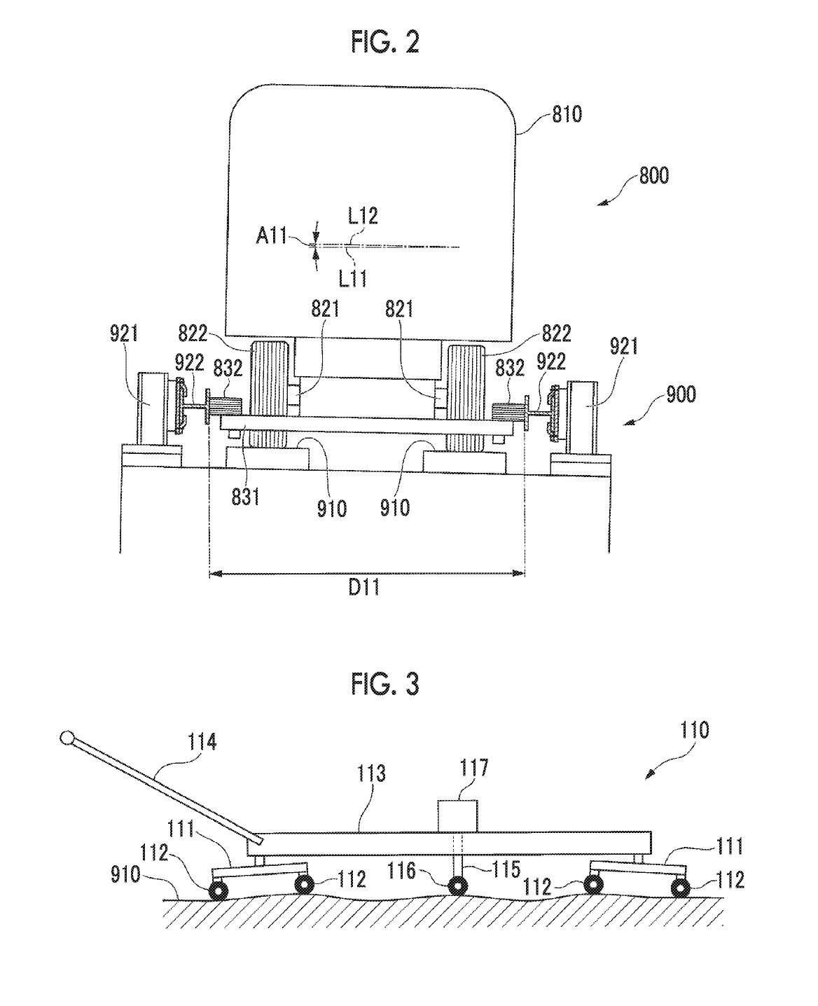

Here, the relationship between a course and a vehicle will be described with reference to FIG. 2.

FIG. 2 is an explanatory diagram illustrating an example in which a vehicle and a course are seen from the front of the vehicle. In a vehicle 800 shown in FIG. 2, a first shaft 821 is provided under a vehicle body 810, and travel tires 822 are provided at both ends of the first shaft 821. A second shaft 831 is provided under the vehicle body 810, and guide wheels 832 are provided at both ends of the second shaft 831.

A support column 921 is provided on each of the left and right sides of the road surface 910 of the course 900, and a guide rail 922 is provided on the support column 921.

In addition, FIG. 2 shows a distance between guide rail tracks D11 and a road surface inclination angle A11. The distance between guide rail tracks D11 is a distance between the left and right guide rails 922. The road surface inclination angle A11 is an angle between a horizontal line L11 and a line L12 parallel to the road surface 910 along the left and right direction of the vehicle.

The traveling tire 822 rotates while being in contact with the road surface 910, thereby causing the vehicle 800 to travel.

In a case where there is unevenness on the road surface 910, an acceleration in the vertical direction is generated in the vehicle 800 traveling on the road surface 910. The acceleration in the vertical direction may lower the ride comfort of the vehicle 800.

Further, the guide wheels 832 are in contact with the guide rail 922 and determines the direction in which the vehicle 800 travels. In a case where there is unevenness in the guide rail 922, an acceleration in the left and right direction is generated in the traveling vehicle 800. The acceleration in the left and right direction may lower the ride comfort of the vehicle 800.

In the following, a description is given about an example in which the measurement device 100 is provided with profile meter to measure road surface unevenness amount and the road surface inclination angle and acquire the measurement position information. However, the method by which the measurement device 100 measures the road surface unevenness amount and the road surface inclination angle and acquires the measurement position information is not limited to the method using a profile meter. Instead of or in addition to a profilometer, the measurement device 100 may be provided with either a laser displacement sensor, a theodolite or an inclinometer, or a combination thereof, and measure the road surface unevenness amount and the inclination angle.

The measurement device 100 may be provided with a Global Navigation Satellite System (GNSS) to acquire measurement position information. Alternatively, the measurement device 100 may include a distance measuring device, which is a combination of a roller and an encoder, separately from the profile meter to acquire measurement position information.

The measurement device 100 is equipped with for example, a laser displacement meter to measure the unevenness amount of the guide rail and the distance between guide rail tracks.

The course correction procedure generation device 200 generates a course correction procedure, based on the measurement data on the course by the measurement device 100. The course correction procedure referred to here is information indicating the course correction content. Specifically, the correction procedure is information indicating a method for correcting one or both of the unevenness of the course road surface and the unevenness of the guide rail in order to improve the ride comfort of the vehicle.

The course correction procedure generation device 200 is configured to include, for example, a computer.

The communication unit 210 communicates with other devices. In particular, the communication unit 210 corresponds to an example of a measurement data acquisition unit, and the measurement device 100 receives measurement data obtained by measuring the course. By this reception, the communication unit 210 acquires measurement data.

The display unit 220 has a display screen such as for example, a liquid crystal panel, and displays various images. In particular, the display unit 220 corresponds to an example of the correction procedure output unit and displays the correction procedure generated by the course correction procedure generation device 200.

The method by which the course correction procedure generation device 200 outputs the correction procedure is not limited to the method in which the display unit 220 displays the correction procedure. For example, the communication unit 210 may transmit the correction procedure to other devices.

The operation input unit 230 has, for example, operating devices such as a keyboard and a mouse, and receives user operations.

The storage unit 280 is configured using a storage device provided in the course correction procedure generation device 200, and stores various types of information.

The control unit 290 controls each unit of the course correction procedure generation device 200 to execute various functions. The control unit 290 is realized, for example, by a Central Processing Unit (CPU: central processing device) provided in the course correction procedure generation device 200 reading and executing a program from the storage unit 280.

The measurement data correction unit 291 corrects the measurement value of the distance of the section in the course. Specifically, with respect to a section of which distance is known in the course, the measurement data correction unit 291 corrects a measurement value of a distance of each section based on the comparison between the measurement value of the distance acquired by the communication unit 210 and the known distance. In particular, the measurement data correction unit 291 corrects the measurement value of the distance of a section having a length equal to or longer than the distance calculated based on the speed of the vehicle and the natural frequency of the vehicle.

Here, there is a case where a shift of about kilometers from the measurement value occurs due to the cause such as the unevenness of the road surface and correction is required. Even in this case, the presence or absence of correction has little effect, for short sections. Therefore, as described later, the measurement data correction unit 291 performs correction for a long section, but omits correction for a short section. Thus, the load of the measurement data correction unit 291 can be reduced.

The simulation execution unit 292 executes travel simulation which simulates travel of a vehicle on the course, based on the measurement data by the measurement device 100 and a speed predetermined according to a position of the vehicle on the course. In particular, the simulation execution unit 292 performs travel simulation in a case where the vehicle travels the course corrected according to the correction procedure. In simulation, the simulation execution unit 292 calculates a position of the vehicle to be simulated in the course, based on the information on the distance corrected by the measurement data correction unit 291.

The correction need determination unit 293 determines whether or not the course correction is necessary. Specifically, the correction need determination unit 293 detects the maximum value of the magnitude of the acceleration of the vehicle in the vertical direction and the maximum value of the magnitude of the acceleration of the vehicle in the left and right direction, from the simulation result by the simulation execution unit 292. Then, the correction need determination unit 293 compares the maximum value of the magnitude of the acceleration of the vehicle in the vertical direction and the maximum value of the magnitude of the acceleration of the vehicle in the left and right direction with the respective threshold values.

In a case where either one of the maximum value of the magnitude of the acceleration of the vehicle in the vertical direction and the maximum value of the magnitude of the acceleration of the vehicle in the left and right direction is equal to or greater than each threshold value, the correction need determination unit 293 determines that the course needs to be corrected. On the other hand, in a case where both the maximum value of the magnitude of the acceleration of the vehicle in the vertical direction and the maximum value of the magnitude of the acceleration of the vehicle in the left and right direction is less than the threshold values, the correction need determination unit 293 determines that the course does not need to be corrected.

The correction need determination unit 293 considers errors that can be included in the simulation result when determining whether or not course correction is necessary. Specifically, the correction need determination unit 293 multiplies the acceleration obtained by the simulation by the error consideration coefficient to be described later.

The correction procedure generation unit 294 generates information indicating the course correction procedure based on the result of travel simulation. In particular, the correction procedure generation unit 294 performs an optimization calculation using an evaluation function related to the grinding work amount of the road surface constituting the course and the filling work amount of the road surface to determine the grinding work amount and the filling work amount. As the evaluation function in this case, an evaluation function including a term in which a weighting corresponding to the cost of a grinding work is given to a variable indicating a grinding work amount of the road surface and a term in which a weighting corresponding to the cost of a filling work is given to a variable indicating a filling work amount of the road surface can be used.

Then, the correction procedure generation unit 294 generates a correction procedure according to the determined grinding work amount and filling work amount.

The correction cost can be reduced by optimization calculation using the evaluation function. The correction cost referred to here is the cost to correct the course. The correction cost may be the cost required for course correction.

For example, in a case where the filling work requires higher cost per unit area than the grinding work, the weighting factor of the filling work is set to a relatively large value and the weighting factor of the grinding work is set to a relatively small value. This makes it easier for the grinding work to be selected than the filling work. It is possible to reduce the cost of correction because the grinding work with a low cost is easily selected.

The correction procedure evaluation unit 295 evaluates the correction procedure generated by the correction procedure generation unit 294.

In particular, the correction procedure evaluation unit 295 determines whether the ride comfort is good or bad, by using a corrected fluctuation amount obtained correction of adding the expected amount of the magnitude of the error included in the magnitude of the fluctuation to the magnitude of the fluctuation of the vehicle indicated by the result of the travel simulation performed in the case where the vehicle travels the course corrected according to the correction procedure.

Specifically, similarly to the case of the correction need determination unit 293, the correction procedure evaluation unit 295 multiplies the acceleration obtained by the simulation by the error consideration coefficient.

Next, with reference to FIG. 3, correction of the measurement value of the distance performed by the measurement data correction unit 291 will be described.

FIG. 3 is an explanatory view illustrating an example of the schematic structure of the profilometer. FIG. 3 shows an example of a schematic outline when the profile meter is viewed from the side. As shown in FIG. 3, the profile meter 110 includes a support leg portion 111, a chassis portion 113, a steering wheel portion 114, a measurement leg portion 115, and a measurement unit 117. The support leg portion 111 includes a support tire 112. The measurement leg portion 115 includes a measurement tire 116.

The profile meter 110 is towed by the measuring worker on the road surface 910 of the course to measure the unevenness of the road surface 910. The measuring worker here is a person who performs the course measurement.

The support leg portion 111 is provided at each of the front and rear of the chassis portion 113, and supports the chassis portion 113 approximately horizontally. Further, when the measuring worker tows the profile meter 110, the support tire 112 of the support leg portion 111 rotates, whereby the profile meter 110 moves along the road surface 910.

In the longitudinal direction of the chassis portion 113, the side on which the steering wheel portion 114 is provided is referred to as the front side of the chassis portion 113, and the side on which the steering wheel portion 114 is not provided is referred to as the rear side of the chassis portion 113. The same is true for the front and rear of the profile meter 110. Since the measuring worker tows the profile meter 110, the profile meter 110 moves to the side where the steering wheel portion 114 is provided in the longitudinal direction of the chassis portion 113.

The chassis portion 113 is supported by the support leg portion 111 to form a substantially horizontal reference plane.

The steering wheel portion 114 is used by the measuring worker to tow the profile meter 110. Since the measuring worker holds the steering wheel portion 114 and tows the profile meter 110, the profile meter 110 moves along the road surface 910, with the side where the steering wheel portion 114 is provided in the longitudinal direction of the chassis portion 113 as the front side.

The measurement leg portion 115 is vertically movably supported by the chassis portion 113, and moves up and down according to the distance between the reference surface formed by the chassis portion 113 and the road surface 910. Specifically, when the measuring worker tows the profile meter 110, the measurement tire 116 rotates while being in contact with the road surface 910. Since the measurement tire 116 is in contact with the road surface 910, the measurement leg portion 115 is pushed by the road surface 910 and moves upward in a place where the distance between the reference surface and the road surface 910 is short. In the example of FIG. 3, the projection portion of the road surface 910 corresponds to a place where the distance between the reference surface and the road surface 910 is short.

On the other hand, in a place where the distance between the reference surface and the road surface 910 is long, the measurement leg portion 115 moves downward by its own weight. In the example of FIG. 3, the recessed portion of the road surface 910 corresponds to a place where the distance between the reference surface and the road surface 910 is long.

The measurement unit 117 measures and records the unevenness of the road surface 910. Specifically, the measurement unit 117 measures the unevenness of the road surface 910 with reference to the reference surface by measuring the vertical movement of the measurement leg portion 115. The measurement unit 117 measures and records the travel distance of the profile meter 110 based on the rotation number of the measurement tire 116.

The measurement unit 117 transmits the measurement result to the communication unit 210. Every time it is detected that the profile meter 110 moves by a predetermined sampling distance interval, the measurement unit 117 transmits the measurement value of the unevenness of the road surface with the measurement value of the travel distance of the profile meter 110 to the communication unit 210 in association with each other. The measurement unit 117 may transmit the measurement value every measurement is performed. Alternatively, the measurement unit 117 may collectively transmit a plurality of measurement values, such as collectively transmitting all the measurement values to the communication unit 210 after the measurement of the entire course is completed.

The position of the profile meter 110 in the course can be detected using the travel distance of the profile meter 110 measured by the measurement unit 117. For example, the control unit 290 of the course correction procedure generation device 200 detects the position of the profile meter 110 in the course, by comparing the travel distance of the profile meter 110 with the distance from the measurement start position on the course in the design data. The distance from the measurement start position on the course may be about kilometers.

Thus, the control unit 290 can recognize that the measurement value of the unevenness of the road surface by the measurement unit 117 is the measurement value at which position on the course.

The travel distance measured by the measurement unit 117 may include a difference from the travel distance on the design data. In particular, on design data, the distance on the course is usually calculated on a flat surface. That is, on design data, the distance on the course is usually calculated assuming that the road surface 910 of the course is a flat surface. The distance on the course as referred to here may be about kilometers.

On the other hand, the measurement unit 117 measures the travel distance along the uneven road surface. Therefore, the travel distance measured by the measurement unit 117 is likely to be longer than the travel distance of the profile meter 110 calculated on the design data.

Due to an error included in the travel distance measured by the measurement unit 117, there may be a difference between the travel distance measured by the measurement unit 117 and the travel distance on the design data. Examples of factors that cause the error in the travel distance measured by the measurement unit 117 include the resolution of an encoder that converts the rotation number of the measurement tire 116 into a distance, the change in circumferential length due to wear of the measurement tire 116, and sliding of the measurement tire 116.

If the control unit 290 recognizes that the measurement position of the unevenness of the road surface by the measurement unit 117 is different from the actual measurement position due to the difference, there is a possibility that the correction procedure generation unit 294 cannot generate a correct correction procedure. In particular, there is a possibility that the correction procedure generation unit 294 generates a correction procedure indicating correction of a position different from the position to actually be corrected.

Therefore, the measurement data correction unit 291 corrects the measurement value of the travel distance of the profile meter 110. Specifically, when the measurement unit 117 of the profile meter 110 reaches a place of which position can be specified, information of the specified position in addition to the measurement value of unevenness of the road surface and the measurement value of the travel distance of the profile meter 110 is transmitted to the communication unit 210. Examples of a place of which position can be specified include a place of which position the measuring worker knows, such as a place with a milestone. When the measuring worker reaches a position where the position can be specified, the measuring worker inputs the position information to the measurement unit 117 to transmit it to the course correction procedure generation device 200. Alternatively, the measurement unit 117 may automatically acquire the position information and transmit it to the course correction procedure generation device 200.

The measurement data correction unit 291 calculates a correction coefficient based on the measurement value of the travel distance acquired by the communication unit 210 and information on the specified position. Specifically, the measurement data correction unit 291 sets the position of the profile meter 110 at the time of the previous correction as the start point of the travel route. In the case of the correction, the measurement data correction unit 291 sets the position where the measurement unit 117 starts measuring the travel distance as the start point of the travel route.

Then, the measurement data correction unit 291 calculates the travel distance from the start point to the specified position on the design data. The measurement data correction unit 291 calculates a correction coefficient by dividing the travel distance on the design data by the measurement value of the travel distance. Then, the measurement data correction unit 291 multiplies each of the travel distance measurement values measured after previous correction by the correction coefficient. In the case of the first correction, the measurement data correction unit 291 multiplies all the travel distance measurement values by the correction coefficient.

In the case where the positions of which positions can be specified are close to each other, the measurement data correction unit 291 omits correction for the section sandwiched between the two positions of which positions can be specified. Thus, the load of the measurement data correction unit 291 can be reduced.

For example, the measurement data correction unit 291 calculates the reference length by dividing the vehicle speed by the natural frequency of the vehicle. The unit of the vehicle speed in this case is, for example, meter/second. The unit of the natural frequency of the vehicle is, for example, “Hertz=1/sec”. The unit of the reference length is, for example, meter.

In a case where the section between two places of which positions can be specified is shorter than the reference length, the measurement data correction unit 291 omits the correction. On the other hand, in a case where the section between two places of which positions can be specified is equal to or longer than the reference length, the measurement data correction unit 291 corrects the measurement position.

The measurement data correction unit 291 includes a calibration function of the measurement device 100. For example, the measurement data correction unit 291 acquires the calibration coefficient, based on the difference between the measurement value when the measurement device 100 measures the measurement object of which the correct value is known and the correct value. For example, an error included in the measurement value of the measurement device 100 is detected in advance based on the error between the tilt angle measured by the measurement device 100 and the actual tilt angle in a place of which the tilt angle is known.

The course correction procedure generation system 1 receives a user operation for setting the measurement direction. Here, in a case where the AGT has an up line and a down line, it is one-way traffic and the vehicle travels only in one direction on each line. In this case, the speed pattern of the vehicle is only one pattern, but for reasons of construction, the course may be measured in reverse. Therefore, in a case where the operation input unit 230 receives a user operation indicating that the measurement direction and the traveling direction of the vehicle are opposite to each other, the control unit 290 rearranges the data in reverse to match the traveling direction of the vehicle. For example, the simulation execution unit 292 of the control unit 290 rearranges the data in reverse to match the traveling direction of the vehicle.

The measurement device 100 may display the measurement value in real time. Alternatively, the course correction procedure generation device 200 may be configured as a device that can be carried to the site of the course measurement, and the display unit 220 may display the measurement value in real time. Since the measuring worker checks the measurement value while performing the measurement work, the measuring worker can check whether or not the measurement can be performed properly.

The correction procedure evaluation unit 295 may have a function of comparing the data before the road surface correction and the data after the road surface correction. For example, the correction procedure evaluation unit 295 may generate data for comparing the acceleration before the correction and the acceleration after the correction. In the correction procedure evaluation unit 295, the accelerations indicated in the simulation result can be used for both the acceleration before correction and the acceleration after correction. A person in charge of correction can refer to this data and check the degree of improvement in ride comfort by correction.

In particular, in a case where the course correction procedure generation device 200 is configured as a device that can be carried to the site of the course measurement, the person in charge of correction can check how much ride comfort is improved from a result of the correction.

The operation input unit 230 receives a user operation for setting vehicle specifications and vehicle speed. Examples of vehicle specifications include a spring constant, a body length, or the like. Further, as the setting of the speed of the vehicle, a relationship between kilometers and the speed, such as for example, the speed for each kilometer, is set. The storage unit 280 stores the set data, and the simulation execution unit 292 performs simulation based on this data.

Further, the control unit 290 calculates the amount of deviation. The amount of deviation referred to here is the difference from the reference value. Examples of the amount of deviation calculated by the control unit 290 can include each amount of height deviation, level deviation, planarity deviation, guide rail stray deviation and deviation between tracks, of the road surface. For example, the correction procedure evaluation unit 295 of the control unit 290 calculates the amounts of deviation. The control unit 290 calculates the amounts of deviation from the measurement data on the course by the measurement device 100. The amounts of deviation are used as data for managing the course, for example.

In the course correction procedure generation system 1, even in a case where measurement of course is interrupted in progress, it is possible to continue to measure data with the data measured last time as an initial value. The measurement of course here is the measurement of unevenness of the course, for example. By connecting the data before and after the interruption, ride comfort evaluation by travel simulation can be performed without interruption.

Further, in the course correction procedure generation system 1, an operation is possible in which for example, only the section in which the correction planner has focused, such as a section expected to have a bad ride comfort is measured again, and the previous measurement data is used for the other sections.

As described above, since the course correction procedure generation device 200 is configured as a device that can be carried to the site of the course measurement, it is possible to perform all processes within the course correction procedure generation device 200, and to evaluate the correction on the construction site. Further, even in a case where the measurement is interrupted, there is no need to return to the starting point.

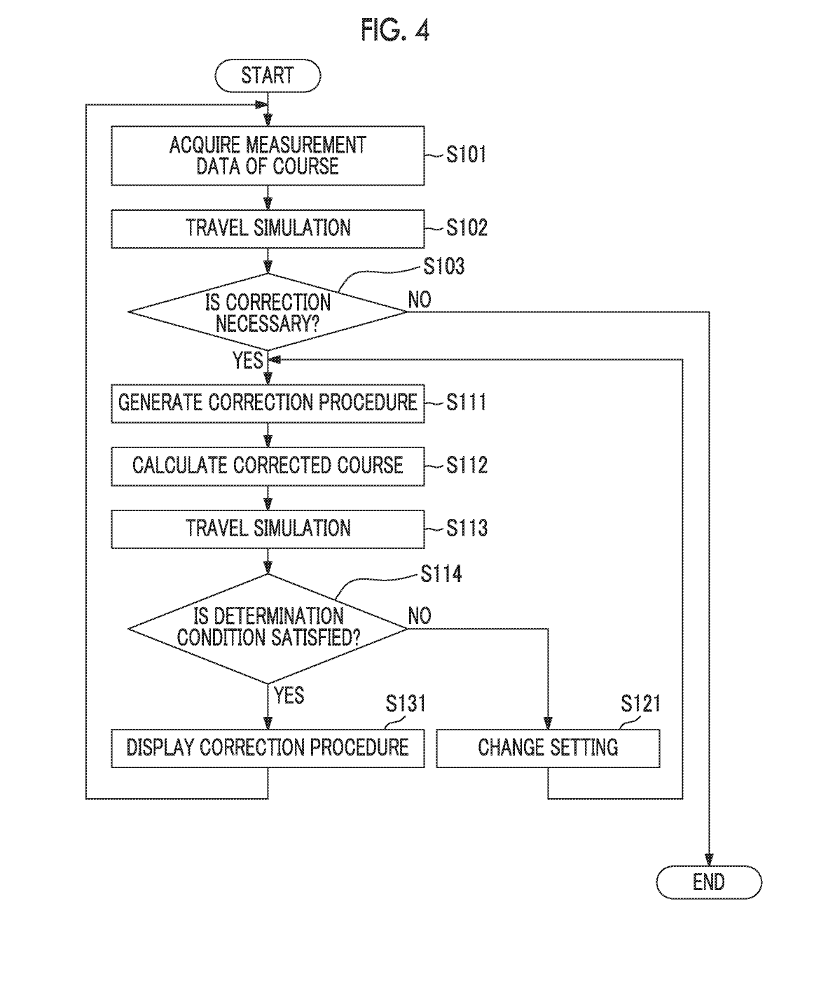

Next, the operation of the course correction procedure generation device 200 will be described with reference to FIG. 4. FIG. 4 is a flowchart showing a processing procedure in which the course correction procedure generation device 200 generates correction procedure.

In the process of FIG. 4, the communication unit 210 acquires measurement data on a course (step S101). Specifically, the measurement device 100 measures a course to generate measurement data indicating the unevenness amount (displacement) of the road surface, the unevenness amount (displacement) of the guide rail, and the measurement position, and transmits the measurement data to the course correction procedure generation device 200. The measurement value of the unevenness amount of the road surface referred to here may be the measurement value of the displacement due to the unevenness of the road surface. The measurement value of the unevenness amount of the guide rail may be the measurement value of the displacement due to the unevenness of the guide rail. The communication unit 210 receives the measurement data transmitted by the measurement device 100.

Next, the simulation execution unit 292 performs travel simulation of the vehicle based on the measurement data obtained in step S101 (step S102). Specifically, the simulation execution unit 292 calculates the behavior of the vehicle when the vehicle travels the course, based on the measurement data obtained in step S101, the predetermined vehicle specifications, and the vehicle speed data in which the vehicle position and the vehicle speed at the position are associated with each other. The simulation execution unit 292 outputs a simulation result indicating the magnitude of the acceleration of the vehicle in the vertical direction and the magnitude of the acceleration of the vehicle in the left and right direction.

The vehicle specifications here are parameters indicating the characteristics of the vehicle. The values in the vehicle specifications are predetermined based on, for example, design data of the vehicle. Examples of vehicle specifications include the weight of the vehicle, the spring constant of the suspension provided in the vehicle, and the natural frequency of the vehicle, but are not limited thereto.

As a simulation method used by the simulation execution unit 292, for example, a known method such as a method using an equation of motion as a model can be used.

Next, the correction need determination unit 293 determines whether or not a course needs to be corrected, based on the simulation result (step S103). Specifically, in at least one of the cases where the maximum value of the acceleration in the vertical direction is equal to or greater than the vertical acceleration threshold value and where the maximum value of the acceleration in the horizontal direction is equal to or greater than the horizontal acceleration threshold value, the correction need determination unit 293 determines that the course needs to be corrected.

Here, both the vertical acceleration threshold value and the horizontal acceleration threshold value are positive constants determined in advance according to the required degree of ride comfort.

Further, the correction need determination unit 293 considers errors that can be included in the simulation result when determining whether or not course correction is necessary.

Specifically, the correction need determination unit 293 multiplies the acceleration obtained by the simulation by the error consideration coefficient. The error consideration coefficient referred to here is coefficient indicating the magnitude of the error considered to be included in the simulation result. The error consideration coefficient is set based on, for example, the difference between the simulation result in the case example for the past course correction and the actual measurement value of an acceleration.

For example, in a case where the error consideration coefficient of the acceleration in the vertical direction is set to 5 percent (%), the correction need determination unit 293 multiplies the maximum value of the acceleration in the vertical direction obtained in the simulation in step S103 by 1.05. That is, the correction need determination unit 293 adds the maximum value of the acceleration in the vertical direction to 5 percent thereof. Then, the correction need determination unit 293 compares the maximum value of the acceleration in the vertical direction obtained from the result of multiplication with the vertical acceleration threshold value. Similarly, in a case where the error consideration coefficient of the acceleration in the left and right direction is set to 10 percent (%), the correction need determination unit 293 multiplies the maximum value of the acceleration in the left and right direction obtained in the simulation in step S103 by 1.1. That is, the correction need determination unit 293 adds the maximum value of the acceleration in the left and right direction to 10 percent thereof. Then, the correction need determination unit 293 compares the maximum value of the acceleration in the left and right direction obtained from the result of multiplication with the left and right acceleration threshold value.

In order to calculate the error consideration coefficient, for example, information on the error between the actual measurement value in the past case and the simulation result is made as a data base. For example, for each course section in the cast case, (1) the standard deviation of the error between the design value and the actual measurement value of the road surface unevenness amount, (2) the travel speed of the vehicle in the test travel, and (3) the error of acceleration of the vehicle in the test travel and the simulation are accumulated in the data base.

Then, the correction need determination unit 293 acquires the standard deviation of the error between the design value and the actual measurement value of the road surface unevenness amount (1) and the travel speed of the vehicle in the test travel (2). The correction need determination unit 293 searches the data base using the obtained data as a search key. In the search, the correction need determination unit 293 selects data having the same standard deviation of the error between the design value and the actual measurement value of the road surface unevenness amount (1) and the same travel speed of the vehicle in the test travel (2) as the values indicated by the search key, from among data for each section of a course stored in data base. For example, the correction need determination unit 293 selects all data in which a difference between all of the values of (1) and (2) and the values indicated in the search key is a predetermined threshold value or less, (1) is the standard deviation of the error between the design value and the actual measurement value of the road surface unevenness amount, and (2) is the travel speed of the vehicle in the test travel. The correction need determination unit 293 acquires the errors ((3)) of the acceleration of the vehicle in the test travel and the simulation, shown in the selected data. The correction need determination unit 293 adopts the largest one among the obtained errors ((3)) of the acceleration of the vehicle in the test travel and the simulation, as an error consideration coefficient.

The storage unit 280 may store the actual measurement value of acceleration in the test travel and the calculated acceleration value in the simulation, instead of the errors ((3)) of the acceleration of the vehicle in the test travel and the simulation. In this case, the correction need determination unit 293 calculates the errors ((3)) of the acceleration of the vehicle in the test travel and the simulation, from the actual measurement value of acceleration in the test travel and the calculated acceleration value in the simulation, stored in the storage unit 280.

The correction need determination unit 293 may use the standard deviation of the distance from the reference position measured by the profile meter to the road surface, as the road surface unevenness amount.

Regarding the swing of the vehicle in the left and right direction, the correction need determination unit 293 uses, for example, one or both of the standard deviation of the error between the design value and the actual measurement value of the distance between guide rail tracks and the standard deviation of the error between the design value and the measured value of the inclination angle of the road surface.

The correction need determination unit 293 may determine the necessity of course correction by using the effective value of the acceleration instead of the maximum value of the acceleration.

In a case where it is determined in step S103 that correction is unnecessary (step S103: NO), the control unit 290 ends the process of FIG. 4.

On the other hand, in a case where it is determined in step S103 that correction is necessary (step S103: YES), the correction procedure generation unit 294 generates a correction procedure (step S111). The correction procedure generation unit 294 determines the correction contents by performing the optimization calculation based on the constraint condition and the evaluation function.

For example, the correction procedure generation unit 294 calculates the correction acceleration effective value based on the acceleration waveform of the vehicle body in the vertical direction and the acceleration waveform in the left and right direction. The corrected acceleration effective value referred to here is a value obtained by correcting the acceleration taking account of the influence on the ride comfort. The corrected acceleration effective value can be calculated based on, for example, regulation of JIS7760, but it is not limited thereto. In JIS7760, the corrected acceleration effective value is calculated by multiplying each acceleration frequency by the coefficient according to the degree of influence on the ride comfort.

The correction procedure generation unit 294 selects a section having a bad ride comfort based on the obtained corrected acceleration effective value. By considering the vehicle speed in the simulation performed by the simulation execution unit 292, the correction procedure generation unit 294 makes a determination based on the ride comfort considering the vehicle speed. Specifically, even in the section where the ride comfort becomes worse if a vehicle travels at a high speed, in a case where the vehicle travels only at low speed in that section, the correction procedure generation unit 294 may determine that correction is unnecessary.

Examples of the constraint conditions used by the correction procedure generation unit 294 for the optimization calculation include the maximum amount of road surface correction, the maximum adjustment amount of the guide rail, and the correction section unit.

As the maximum amount of road surface correction, for example, information indicating the maximum value of grinding amount or the maximum value of filling amount at that position can be used in association with the position in the course. For example, this information designates the position in the course, and indicates that grinding at that position is 3 millimeter (mm) or less.

As the maximum amount of guiderail correction, for example, information indicating the maximum value of the guide rail adjustment amount at that position can be used in association with the position in the course. For example, this information designates the position in the course, and indicates that the guide rail adjustment amount at that position is 5 millimeter (mm) or less.

For example, information indicating the minimum value of the pitch at which the road surface can be ground can be used as the correction section unit. The pitch of the road surface referred to here is the section length of the road surface. The information indicates that for example, the pitch at which the road surface can be grounded is a minimum of 250 mm.

In addition, the correction procedure generation unit 294 performs optimization calculation to minimize the value of the evaluation function (objective function) shown in for example, Expression (1).

[Expression 1]

α1×grinding volume+β1×filling volume+γ1×(acceleration excess amount)² (1)

Here, α1, β1, and γ1 are weighting factors, respectively. The values of α1, β1, and γ1 are all predetermined with positive constant values.

Grinding volume is the volume to grind the road surface for correction. The filling volume is the volume to fill the road surface for correction. The acceleration excess amount indicates the excess amount from the reference value of the acceleration in the vertical direction which is expected after course correction execution. The correction procedure generation unit 294 calculates an acceleration excess amount based on Expression (2).

$$[ Expression 2 ]$$

$$\begin{matrix}acceleration \\ excess amount\end{matrix} = \{ \begin{matrix}0 ( \begin{matrix}\vert vertical \vert \\ acceleration\end{matrix} \begin{matrix}≦ \\ \end{matrix} \begin{matrix}reference \\ value \end{matrix} ) \\ \begin{matrix}\vert vertical \vert \\ acceleration\end{matrix} - \begin{matrix}reference \\ value \end{matrix} \begin{matrix}( \vert vertical \vert > \\ acceleration \end{matrix} \begin{matrix}reference \\ value \end{matrix} )\end{matrix} \qquad ( 2 )$$

The vertical acceleration referred to here is the acceleration of the vehicle in the vertical direction. Further, the reference value is a predetermined positive constant.

In a case where the magnitude of the vertical acceleration is equal to or less than the reference value, the correction procedure generation unit 294 calculates the acceleration excess amount as zero. The size here means an absolute value. On the other hand, in a case where the magnitude of the vertical acceleration is greater than the reference value, the correction procedure generation unit 294 calculates the acceleration excess amount as a value obtained subtracting the reference value from the magnitude of the vertical acceleration.

Increasing the value of the weighting factor α1 as compared with the value of the weighting factor β1 reduces the grinding volume obtained as a result of the optimization calculation. In a case where the cost of grinding is greater than the cost of filling, by increasing the value of the weighting factor α1, it is possible to try to reduce the grinding amount and reduce the correction cost. The cost of grinding referred to here may be the cost per unit area in a case of performing grinding. The cost of filling may be the cost per unit area in a case of performing filling.

Conversely, in a case where the cost of filling is greater than the cost of grinding, by increasing the value of the weighting factor β1, it is possible to try to reduce the filling amount and reduce the correction cost. The values of α1 and β1 are determined by the person in charge of the correction planning based on the cost, period, and the like of the correction work.

In general, the cost of filling is higher than the cost of grinding. Therefore, it is conceivable that α1<β1.

When the value of the weighting factor γ1 is reduced by comparison with the value of the weighting factor α1 and the value of the weighting factor β1, the allowance degree of the excessive acceleration amount relatively increases. In the case where deterioration of ride comfort is allowed to some extent, by decreasing the value of the weighting factor γ1, it is possible to reduce the correction amount (filling amount and grinding amount) and reduce the correction cost. On the other hand, by increasing the value of the weighting factor γ1, it is possible to improve the ride comfort by bringing the acceleration excess amount close to zero.

However, the evaluation function used by the correction procedure generation unit 294 is not limited to the function shown in Expression (1). For example, the correction procedure generation unit 294 may perform optimization calculation to minimize the value of the evaluation function shown in Expression (3).

[Expression 3]

α2×grinding section length+β2×filling section length+γ2×(acceleration excess amount)² (3)

Here, α2, β2, and γ2 are weighting factors, respectively. The values of α2, β2, and γ2 are all predetermined with positive constant values.

Further, the grinding section length is the length of the section where the road surface is ground for correction. Further, the filling section length is the length of the section where the road surface is filled for correction.

Increasing the value of the weighting factor α2 as compared with the value of the weighting factor β2 reduces the grinding volume obtained as a result of the optimization calculation. In a case where the cost of grinding is greater than the cost of filling, by increasing the value of the weighting factor α2, it is possible to try to reduce the grinding amount and reduce the correction cost. Conversely, in a case where the cost of filling is greater than the cost of grinding, by increasing the value of the weighting factor β2, it is possible to try to reduce the filling amount and reduce the correction cost. The values of α2 and β2 are determined by the person in charge of the correction planning based on the cost period, and the like of the correction work.

In general, the cost of filling is higher than the cost of grinding. Therefore, it is conceivable that α2<β2.

When the value of the weighting factor γ2 is reduced by comparison with the value of the weighting factor α2 and the value of the weighting factor β2, the allowance degree of the excessive acceleration amount relatively increases. In the case where deterioration of ride comfort is allowed to some extent, by decreasing the value of the weighting factor γ2, it is possible to reduce the correction amount and reduce the correction cost. On the other hand, by increasing the value of the weighting factor γ2, it is possible to improve the ride comfort by bringing the acceleration excess amount close to zero.

Alternatively, the correction procedure generation unit 294 may perform optimization calculation to minimize the value of the evaluation function shown in Expression (4).

[Expression 4]

α1×grinding volume+β1×filling volume+α2×grinding section length+β2×filling section length+γ3×(acceleration excess amount)² (4)

Here, γ3 is a weighting factor. The value of γ3 is predetermined with a positive constant value.

When the value of the weighting factor γ3 is reduced by comparison with each of the values of the weighting, factors α1, α2, β1, and β2, the allowance degree of the excessive acceleration amount relatively increases. In the case where deterioration of ride comfort is allowed to some extent, by decreasing the value of the weighting factor γ3, it is possible to reduce the correction amount and reduce the correction cost. On the other hand, by increasing the value of the weighting factor γ3, it is possible to improve the ride comfort by bringing the acceleration excess amount close to zero.

In addition, correction procedure generation unit 294 generates a correction procedure of the guide rail using an optimization function with the section length for performing correction and the amount to cause the guide rail to move back and forth as parameters.

Here, the guide rail 922 (FIG. 2) is fixed to the support column 921 with screws, and the guide rail can be moved back and forth by adjusting the screw. The “forth” referred to here is the direction to shorten the distance between guide rail tracks, that is, the direction from the support column 921 to the center side of the course 900. Conversely, the “back” referred to here is the direction to lengthen the distance between guide rail tracks, that is, the direction from the support column 921 to the outside of the course 900.

The section length for performing correction may be indicated by a distance or may be indicated by the number of the support columns provided with the screws to be adjusted. In the case where the section length for performing correction is indicated by a distance, the unit of the distance may be meters.

The correction procedure generation unit 294 may generate the correction procedure of the road surface based on the data of the road surface unevenness amount even in a case where there is no data of the guide rail unevenness amount. Specifically, the simulation execution unit 292 executes a simulation based on the data of the road surface unevenness amount and the data of the speed of the vehicle for each position on the course, and calculates the magnitude of the vertical swing. The correction procedure generation unit 294 generates the correction procedure of the road surface based on the obtained magnitude of the swing in the up-down direction.

The correction procedure generation unit 294 may generate the correction procedure of the guide rail based on the data of the guide rail unevenness amount even in a case where there is no data of the road surface unevenness amount. In this case, the simulation execution unit 292 executes a simulation based on the data of the guide rail unevenness amount on the assumption that the road surface is flat and horizontal, and calculates the magnitude of the swing in the left and right direction. The correction procedure generation unit 294 generates the correction procedure of the guide rail based on the obtained magnitude of the swing in the left and right direction.

The correction procedure generation unit 294 may generate the correction procedure for all sections of a course. Alternatively, the correction procedure generation unit 294 may generate the correction procedure only for the section determined to have bad ride comfort. The section that is determined to have a bad ride comfort may be a section in which the magnitude of the acceleration is determined to be equal to or greater than the reference. Since the correction procedure generation unit 294 generates a correction procedure for all sections of the course, for example, instead of the filling work for the section determined as having a bad ride, there is a possibility to be able to generate a correction procedure to perform the grinding work for sections around that section. There is a possibility that the correction cost is reduced by performing the grinding work for the surrounding sections instead of the filling work for the section that is determined to have a bad riding comfort.

After step S111, the control unit 290 calculates the unevenness amount of the course in the case of executing the correction with the correction procedure obtained in step S111 (step S112). For example, the simulation execution unit 292 of the control unit 290 may perform the process of step S112.

After step S112, the simulation execution unit 292 performs travel simulation by using the calculation result obtained in step S112 (step S113).

The correction procedure evaluation unit 295 determines whether not the result of the travel simulation performed in step S113 satisfies the ride comfort condition (step S114). In making the determination, the correction procedure evaluation unit 295 considers the error consideration factor as described above.

In a case where it is determined that the condition is not satisfied (step S114: NO), the correction procedure evaluation unit 295 changes the setting for increasing the correction amount (step S121). For example, the correction procedure evaluation unit 295 increases the correction amount by changing the coefficient value of the evaluation function used by the correction procedure generation unit 294, such as by increasing the value of the weighting factor γ1 in Expression (1).

After step S121, the control unit 290 returns to step S111.

On the other hand, if the correction procedure evaluation unit 295 determines in step S114 that the condition is satisfied (step S114: YES), the display unit 220 displays the correction procedure obtained in step S111 (step S131).

After step S131, the control unit 290 returns to step S101. This is because the unevenness amount of the course after the course is actually corrected is evaluated based on the correction procedure displayed by the display unit 220. As described above, the course correction referred to here is the refurbishment of the course.

As described above, the communication unit 210 acquires the measurement data on a course.

The simulation execution unit 292 executes travel simulation which simulates travel vehicle on the course, based on the measurement data and a speed determined according to a position of the vehicle on the course.

Then, the correction procedure generation unit 294 generates information indicating the course correction procedure based on the result of the travel simulation.

Since the simulation execution unit 292 performs the travel simulation based on the speed determined according to the position of the vehicle, the ride comfort can be improved without having to actually run the vehicle.

Here, the ride comfort of the vehicle is influenced not only by the road surface unevenness amount but also by the vehicle speed vehicle characteristics (vehicle specifications such as a natural frequency and a spring constant). Therefore, in some cases, a method is used in which the ride comfort is evaluated by actually running the vehicle, and the correction place and correction method of the course are determined. As described above, the vehicle characteristics are indicated the vehicle specifications.

On the other hand, in the course correction procedure generation system 1, the ride comfort can be improved without having to actually run the vehicle, as described above. Thus, in the course correction procedure generation system 1, the burden on the person in charge of correction can be reduced because the ride comfort verification work by the running of the vehicle becomes unnecessary, and the correction initiation can be advanced.

In particular, since the course is corrected according to the correction procedure indicated by the course correction procedure generation system 1, the ride comfort can be made higher than the standard used by the course correction procedure generation system 1. Specifically, the acceleration during travel of the vehicle can be made equal to or less than the reference acceleration.

Further, since the course correction procedure generation system 1 generates a correction procedure based on the speed of the vehicle, it is possible to suppress unnecessary correction for a section where the vehicle travels at low speed and the acceleration does not increase. As described above, according to the course correction procedure generation system 1, correction can be performed efficiently.

Further, the simulation execution unit 292 performs travel simulation in a case where the vehicle travels the course corrected according to the correction procedure.

The correction procedure evaluation unit 295 determines whether the ride comfort is good or bad, by using a corrected fluctuation amount obtained by correction of adding the expected amount of the magnitude of the error included in the magnitude of the fluctuation to the magnitude of the fluctuation of the vehicle indicated by the result of the travel simulation performed in a case where the vehicle travels the course corrected according to the correction procedure.

As described above, the correction procedure evaluation unit 295 evaluates the ride comfort taking into consideration the magnitude of the error included in the simulation result, such that it is possible to reduce the possibility that re-correction is necessary due to insufficient improvement of ride comfort in the correction based on the correction procedure.

The correction procedure generation unit 294 determines the grinding work amount and the filling work amount by performing an optimization calculation using an evaluation function including a term for giving a weighting according to the cost of the grinding work to a variable indicating the grinding work amount of the road surface constituting the course and a term for giving a weighting according to the cost of the filling work to a variable indicating the filling work amount of the road surface. The correction procedure generation unit 294 generates a correction procedure according to the determined grinding work amount and filling work amount.

As described above, since the correction procedure generation unit 294 performs the optimization calculation using the evaluation function in which weighting is given to the variable indicating the work according to the cost of the work, the cost of the correction work can be reduced.

Further, with respect to a section of which distance is known among the sections in the course, the measurement data correction unit 291 corrects a measurement value of a distance of each section based on the measurement value of the distance acquired by the communication unit 210. The simulation execution unit 92 calculates a position of the vehicle to be simulated in the course, based on the information on the distance corrected by the measurement data correction unit 291.

As described above, the measurement data correction unit 291 corrects the measurement value of the distance, whereby the simulation execution unit 292 can perform travel simulation with higher accuracy.

In addition, the measurement data correction unit 291 corrects the measurement value of the distance of a section having a length equal to or longer than the distance calculated based on the speed of the vehicle and the natural frequency of the vehicle.

As described above, by limiting the object for which the measurement data correction unit 291 corrects the distance, the load of the measurement data correction unit 291 can be reduced.

A program for realizing all or a part of the functions of the control unit 290 recorded on a computer readable recording medium, and the process of each unit may be performed by the program recorded on the recording medium being read and executed by the computer system. The “computer system” referred to here includes OS and hardware such as peripheral devices.

Further, “computer-readable recording medium” refers to a storage device such as a flexible disk, a magneto-optical disk, a portable medium such as a ROM and a CD-ROM, and a hard disk built in a computer system. Further, the program may be intended to realize a part of the above-described functions, and may be intended to realize the above-described functions by combining them with the program already recorded in the computer system.

Although the embodiments of the present invention have been described in detail with reference to the drawings, specific configurations are not limited to the above-described embodiments, and design changes and the like within the scope not deviating from the gist of the present invention are included.

### INDUSTRIAL APPLICABILITY

The embodiment of the present invention relates to a course correction procedure generation device including a measurement data acquisition unit that acquires measurement data on a course; a simulation execution unit that executes travel simulation which simulates travel of a vehicle on the course, based on the measurement data and a speed determined according to a position of the vehicle on the course; and a correction procedure generation unit that generates a correction procedure which is information indicating correction content of the course, based on a result of the travel simulation.

According to the present embodiment, the ride comfort can be improved without having to actually run the vehicle.

### REFERENCE SIGNS LIST

1 COURSE CORRECTION PROCEDURE GENERATION SYSTEM

100 MEASUREMENT DEVICE

200 COURSE CORRECTION PROCEDURE GENERATION DEVICE

210 COMMUNICATION UNIT

220 DISPLAY UNIT

230 OPERATION INPUT UNIT

280 STORAGE UNIT

290 CONTROL UNIT

291 MEASUREMENT DATA CORRECTION UNIT

292 SIMULATION EXECUTION UNIT

293 CORRECTION NEED DETERMINATION UNIT

294 CORRECTION PROCEDURE GENERATION UNIT

295 CORRECTION PROCEDURE EVALUATION UNIT

1. A course correction procedure generation device comprising:
a measurement data acquisition unit that acquires measurement data on a course;
a simulation execution unit that executes travel simulation which simulates travel of a vehicle on the course, based on the measurement data and a speed determined according to a position of the vehicle on the course; and
a correction procedure generation unit that generates a correction procedure which is information indicating correction content of the course, based on a result of the travel simulation.

2. The course correction procedure generation device according to claim 1, further comprising:
a correction procedure evaluation unit that evaluates the correction procedure,
wherein the simulation execution unit performs a travel simulation corresponding to a case where the vehicle travels the course corrected according to the correction procedure, and
wherein the correction procedure evaluation unit evaluates the correction procedure based on a result of the travel simulation performed in the case where the vehicle travels the course corrected according to the correction procedure.

3. The course correction procedure generation device according to claim 2,
wherein the correction procedure evaluation unit evaluates the correction procedure by determining whether ride comfort of the vehicle is good or bad, based on the result of the travel simulation performed in the case where the vehicle travels the course corrected according to the correction procedure.

4. The course correction procedure generation device according to claim 3,
wherein the correction procedure evaluation unit determines whether the ride comfort of the vehicle is good or bad, by using a corrected fluctuation amount obtained by correcting a magnitude of fluctuation of the vehicle indicated by the result of the travel simulation performed in the case where the vehicle travels the course corrected according to the correction procedure, based on a prospective amount of a value indicating an error.

5. The course correction procedure generation device according to claim 3, further comprising:
a correction procedure output unit that outputs a correction procedure based on a simulation result determined to have good ride comfort, in a case where the correction procedure evaluation unit determines that the ride comfort is good.

6. The course correction procedure generation device according to claim 1,
wherein the correction procedure generation unit determines a grinding work amount and a filling work amount based on a cost of a grinding work of a road surface constituting the course and a cost of a filling work of the road surface, and generates a correction procedure according to the determined grinding work amount and filling work amount.

7. The course correction procedure generation device according to claim 6,
wherein the correction procedure generation unit determines the grinding work amount and the filling work amount by performing an optimization calculation using an evaluation function including a term for giving a weighting according to the cost of the grinding work to a variable indicating the grinding work amount of the road surface constituting the course and a term for giving a weighting according to the cost of the filling work to a variable indicating the filling work amount of the road surface.

8. The course correction procedure generation device according to claim 1, further comprising:
a measurement data correction unit that corrects a measurement value of a distance of each section based on the measurement value of the distance acquired by the measurement data acquisition unit with respect to a section of which distance is known among sections in the course,
wherein the simulation execution unit calculates a position of the vehicle to be simulated in the course, based on the information on the distance corrected by the measurement data correction unit.

9. The course correction procedure generation device according to claim 8,
wherein the measurement data correction unit corrects the measurement value of the distance of a section having a length equal to or longer than the distance calculated based on the speed of the vehicle and a natural frequency of the vehicle.

10. A course correction procedure generation system comprising:
a measurement device that performs measurement of a course and outputs measurement data;
a simulation execution unit that executes travel simulation which simulates travel of a vehicle on the course, based on the measurement data and a speed determined according to a position of the vehicle on the course; and
a correction procedure generation unit that generates a correction procedure which is information indicating correction content of the course, based on a result of the travel simulation.

11. A course correction procedure generation method comprising:
acquiring measurement data on a course;
executing travel simulation which simulates travel of a vehicle on the course, based on the measurement data and a speed determined according to a position of the vehicle on the course; and
generating a correction procedure which is information indicating correction content of the course, based on a result of the travel simulation.

12. A program causing a computer to
acquire measurement data on a course;
execute travel simulation which simulates travel of a vehicle on the course, based on the measurement data and a speed determined according to a position of the vehicle on the course; and
generate a correction procedure which is information indicating correction content of the course, based on a result of the travel simulation.
